(19) United States
(12) Patent Application Publication
(10) Pub. No.: US 2026/0312746 A1
(43) Pub. Date: Oct. 8, 2026

(54) METHODS AND APPARATUSES FOR MULTI-AP TRANSMISSION

(71) Applicant: CANON KABUSHIKI KAISHA, Tokyo (JP)

(72) Inventors: Patrice NEZOU, LIFFRE (FR); Julien SEVIN, SAINT AUBIN DU CORMIER (FR)

(21) Appl. No.: 19/483,797

(22) PCT Filed: May 7, 2024
(86) PCT No.: PCT/EP2024/062604

§ 371 Date: Nov. 12, 2025

(30) Foreign Application Priority Data
May 12, 2023 (EP) 23305761.1
Jul. 13, 2023 (GB) 2310800.4

(51) Int. Cl. H04L 5/00; H04W 74/00

(52) U.S. Cl. CPC H04L 5/0035; H04W 74/002

(57) ABSTRACT

At least one embodiment of a communication method in a wireless network, comprising, at one of access points (APs) in the wireless network, transmitting or receiving a management frame, wherein the management frame comprises parameters to be used for coordinating APs, wherein the parameters include at least one of an Association Identifier, AID, assigned to an AP to be triggered by another AP, an operating channel wherein an AP transmitting the management frame operates, a preferred channel to be used for multi-AP transmissions, and AIDs of neighboring APs.

### FIELD OF THE DISCLOSURE

The present invention generally relates to wireless communications.

### BACKGROUND OF THE DISCLOSURE

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

In order to address the issue of increasing bandwidth and decreasing latency requirements that are demanded for wireless communications systems in high-density environments, multi-user (MU) schemes are being developed to allow a single access point (AP) managing a Basic Service Set (BSS) to schedule MU transmissions, i.e. multiple simultaneous transmissions to or from non-AP stations of the BSS, in the wireless network. For example, one of such MU schemes has been adopted by the Institute of Electrical and Electronics Engineers (IEEE) in the 802.11ax-2021 standard, published on May 2019.

Thanks to the MU feature, a non-AP station has the opportunity to gain access to the wireless medium via two access schemes: the MU scheme and the conventional Enhanced Distributed Channel Access-EDCA (Single User) scheme.

Each BSS defines a main elementary channel of the wireless medium (known as a primary channel, usually a 20 MHz channel or a multiple of 20 MHz channel) on which the stations (including the AP) perform EDCA contention. To increase bandwidth for the forthcoming transmission, the stations can simultaneously contend for additional 20 MHz channels, known as secondary channels. The communication channel thus granted for transmission comprises the primary channel and optionally secondary channels.

The 802.11ax standard allows a MU downlink (DL) transmission to be performed by the AP when gaining access to the wireless medium for a transmission opportunity (TXOP). During the MU DL transmission on the granted communication channel, the AP performs multiple simultaneous elementary transmissions, over so-called resource units (RUs), to various non-AP stations. As an example, the resource units split the communication channel of the wireless network in the frequency domain, based for instance on Orthogonal Frequency Division Multiple Access (OFDMA) technique. The assignment of the RUs to the non-AP stations is signaled at the beginning of the MU Downlink frame, by providing an association identifier (AID) of a non-AP station (individually obtained by each station during its association procedure with the AP) for each RU defined in the transmission opportunity.

The 802.11ax standard also allows a MU uplink (UL) transmission to be triggered by the AP when gaining access to the wireless medium. During the MU UL transmission, various non-AP stations can simultaneously transmit data to the AP over the resource units forming the communication channel. To control the MU UL transmission by the non-AP stations, the AP previously sends a control frame, known as a Trigger Frame (TF). The Trigger Frame allocates the resource units to the non-AP stations of the same BSS, using 16-bit Association Identifiers (AIDs) assigned to them upon registration to the AP and/or using reserved AIDs designating a group of non-AP stations. The TF also defines the start of the MU UL transmission by the non-AP stations as well as the length thereof.

Recently, the IEEE 802.11be standard Task Group started considering a so-called, Multi-Access Point (Multi-AP or MAP) technology. The latter aims at providing some degree of collaboration among neighbouring access points (APs managing separate BSSs) in order to have a more efficient utilization of time, frequency and spatial resources available. This is particularly important when the neighbouring APs operate over a same communication channel.

On the other hand, the Target Wake Time (TWT) mechanism, originally defined in the IEEE 802.11ah and 802.11ax standards, has been adapted to be included in the 802.11be standard. An adaptation is known as the Restricted Target Wake Time (rTWT) which schedules dedicated (and protected) service periods (SPs) for stations (affiliated with a non-AP Multi-Link Device (MLD)) to convey their latency sensitive traffic(s) over their BSS. An rTWT agreement is nothing more than a Broadcast TWT agreement negotiated between an AP and an associated non-AP station of the BSS of a given link. The non-AP station establishes with the AP membership in a Broadcast TWT (or rTWT) schedule. The rTWT Service Periods (SPs) of the rTWT schedule are advertised in broadcast management frames (e.g., beacons), using an rTWT information about the negotiated rTWT SPs, typically a Broadcast TWT ID (bTWT ID).

### SUMMARY OF DISCLOSURE

It is a broad objective of the present disclosure to enhance the collaboration among neighbouring APs. It is another objective of the present disclosure to coordinate Multi AP transmissions with the TWT or rTWT procedures to, e.g., avoid OBSS (Overlapping Basic Service Sets) interference in between BSSs of a Multi-AP coordinated group.

According to a first aspect of the disclosure, there is provided a communication method in a wireless network, comprising, at an access point, AP, of a plurality of APs in the wireless network:
transmitting or receiving a management frame;
   wherein the management frame comprises multi access point, MAP, parameters to be used for coordinating APs, wherein the MAP parameters include at least one of:
an Association Identifier, AID, assigned to an AP to be triggered by another AP,
an operating channel wherein an AP transmitting the management frame operates,
a preferred channel to be used for MAP transmissions, and
AIDs of neighboring APs.

Accordingly, the method of the disclosure makes it possible to improve multi AP coordination and to limit risks of conflicts, in particular of conflicts between AP identifiers.

In some embodiments, the management frame is a transmitted management request frame, the management request frame comprising a MAP setup command, the MAP setup command being a request command for joining a MAP transmission, a suggest command for joining a MAP transmission with suggested MAP parameters, or a demand command suggesting MAP parameters to be used for coordinating APs.

In some embodiments, the method further comprises, in response to transmitting the management request frame, receiving a management response frame, the management response frame comprising an alternate MAP setup command suggesting the use of MAP parameters different from the corresponding parameters of the management request frame.

In some embodiments, the method further comprises, in response to transmitting the management request frame, receiving a management response frame, the management response frame comprising an accept MAP setup command accepting MAP parameters associated with a suggest or alternate command of the management request frame.

In some embodiments, the method further comprises, in response to transmitting the management request frame, receiving a management response frame, the management response frame comprising a dictate MAP setup command forcing the use of MAP parameters associated with a suggest command of the management request frame.

In some embodiments, the method further comprises, in response to transmitting the management request frame, receiving a management response frame, the management response frame comprising a reject MAP setup command rejecting MAP parameters or comprising a conflict command warning conflicting AIDs.

In some embodiments, the management frame is a received management request frame, the management request frame comprising a request MAP setup command for joining a MAP transmission, a suggest command to join a MAP transmission with suggested MAP parameters, or a demand command suggesting MAP parameters to be used for coordinating APs.

In some embodiments, the method further comprises, in response to receiving the management request frame, analyzing the received management request frame and, in response to the analysis, generating and transmitting a management response frame, the management response frame comprising an alternate MAP setup command suggesting MAP parameters different from the corresponding parameters of the management request frame.

In some embodiments, the method further comprises, in response to receiving the management request frame, analyzing the received management request frame and, in response to the analysis, generating and transmitting a management response frame, the management response frame comprising an accept MAP setup command accepting MAP parameters associated with a suggest or alternate command of the management request frame.

In some embodiments, the method further comprises, in response to receiving the management request frame, analyzing the received management request frame and, in response to the analysis, generating and transmitting a management response frame, the management response frame comprising a dictate MAP setup command forcing the use of MAP parameters associated with a suggest command of the management request frame.

In some embodiments, the method further comprises, in response to receiving the management request frame, analyzing the received management request frame and, in response to the analysis, generating and transmitting a management response frame, the management response frame comprising a reject MAP setup command rejecting MAP parameters received in the management request frame or comprising a conflict MAP setup command warning conflicting AIDs.

In some embodiments, the management frame comprises a Target Wake Time, TWT, information element, the TWT information element comprising the parameters and comprising TWT parameters associated with a MAP setup command.

In some embodiments, the TWT information element comprises a TWT Setup Command field, the TWT Setup Command field comprising a request, suggest, demand, alternated, accept, dictate, reject, or conflict MAP setup command to be transmitted or received.

In some embodiments, the TWT information element comprises a MAP Setup Command field, the MAP Setup Command field comprising a request, suggest, demand, alternated, accept, dictate, reject, or conflict MAP setup command to be transmitted or received.

According to a second aspect of the disclosure, there is provided a management frame to be used in a wireless network comprising a plurality of access points, APs, the management frame comprising multi AP, MAP, parameters to be used for coordinating APs in the wireless network, the parameters including at least one of:
an Association Identifier, AID, assigned to an AP to be triggered by another AP,
an operating channel wherein an AP transmitting the management frame operates,
a preferred channel to be used for multi-AP transmissions, and
AIDs of neighboring APs.

Accordingly, the method of the disclosure makes it possible to improve multi AP coordination and to limit risks of conflicts, in particular of conflicts between AP identifiers.

In some embodiments, the management frame comprises a Target Wake Time, TWT, information element, the TWT information element comprising the parameters and TWT parameters.

In some embodiments, the management frame further comprises a MAP setup command, the MAP setup command being a request, suggest, demand, alternated, accept, dictate, reject, or conflict MAP setup command.

In some embodiments, the TWT information element comprises a TWT Setup Command field, the TWT Setup Command field comprising a request, suggest, demand, alternated, accept, dictate, reject, or conflict AMP setup command.

In some embodiments, the TWT information element comprises a MAP Setup Command field, the MAP Setup Command field comprising a request, suggest, demand, alternated, accept, dictate, reject, or conflict MAP setup command.

At least parts of the methods according to the disclosure may be computer implemented. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit”, “module” or “system”. Furthermore, the present disclosure may take the form of a computer program product embodied in any tangible medium of expression having computer usable program code embodied in the medium.

Since the present disclosure can be implemented in software, the present disclosure can be embodied as computer readable code for provision to a programmable apparatus on any suitable carrier medium. A tangible carrier medium may comprise a storage medium such as a hard disk drive, a magnetic tape device or a solid state memory device and the like. A transient carrier medium may include a signal such as an electrical signal, an electronic signal, an optical signal, an acoustic signal, a magnetic signal or an electromagnetic signal, e.g. a microwave or RF signal.

### BRIEF DESCRIPTION OF THE DRAWINGS

Embodiments of the disclosure will now be described, by way of example only, and with reference to the following drawings in which:

FIG. 1 illustrates an exemplary network environment in which embodiments of the present disclosure may be implemented;

FIG. 2a shows a schematic representation a communication device in accordance with embodiments of the present disclosure;

FIG. 2b is a block diagram schematically illustrating the architecture of the communication device of FIG. 1a, adapted to carry out, at least partially, the disclosure;

FIG. 3a illustrates a format of a Target Wake Time, TWT, information element enhanced to configure multi-AP transmissions according to embodiments;

FIGS. 3b and 3c illustrate examples of a format of a Multi-AP (MAP) Target Wake Time (TWT) information element to negotiate multi-AP transmissions according to some embodiments of the disclosure;

FIGS. 4a and 4b illustrate a format of information element enhanced to configure multi-AP transmissions according to embodiments;

FIGS. 5a and 5b illustrate, using a flowchart, general steps at a sharing AP according to embodiments of the disclosure;

FIG. 6 illustrates, using a flowchart, general steps at a shared AP according to embodiments of the disclosure; and

FIGS. 7a and 7b illustrate, using a flowchart, general steps of an example of a managing multi AP negotiation procedure, at a sharing AP and at a shared AP, respectively, according to embodiments of the disclosure.

### DETAILED DESCRIPTION OF EMBODIMENTS

The techniques described herein may be used for various broadband wireless communication systems, including communication systems that are based on an orthogonal multiplexing scheme. Examples of such communication systems include Spatial Division Multiple Access (SDMA) system, Time Division Multiple Access (TDMA) system, Orthogonal Frequency Division Multiple Access (OFDMA) system, and Single-Carrier Frequency Division Multiple Access (SC-FDMA) system. An SDMA system may utilize sufficiently different directions to simultaneously transmit data belonging to multiple user terminals, i.e., wireless devices or stations. A TDMA system may allow multiple user terminals to share the same frequency channel by dividing the transmission signal into different time slots or resource units, each time slot being assigned to different user terminal. An OFDMA system utilizes orthogonal frequency division multiplexing (OFDM), which is a modulation technique that partitions the overall system bandwidth into multiple orthogonal sub-carriers or resource units. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers.

The teachings herein may be incorporated into (e.g., implemented within or performed by) a variety of apparatuses (e.g., stations). In some aspects, a wireless device or station implemented in accordance with the teachings herein may comprise an access point (so-called AP) or not (so-called non-AP station or STA).

An access point (denoted AP) may comprise, be implemented as, or known as a Node B, Radio Network Controller (“RNC”), evolved Node B (eNB), 5G Next generation base station (gNB), Base Station Controller (“BSC”), Base Transceiver Station (“BTS”), Base Station (“BS”), Transceiver Function (“TF”), Radio Router, Radio Transceiver, Basic Service Set (“BSS”), Extended Service Set (“ESS”), Radio Base Station (“RBS”), or some other terminology.

A non-AP station may comprise, be implemented as, or known as a subscriber station, a subscriber unit, a mobile station (MS), a remote station, a remote terminal, a user terminal (UT), a user agent, a user device, user equipment (UE), a user station, or some other terminology. In some implementations, a STA may comprise a cellular telephone, a cordless telephone, a Session Initiation Protocol (“SIP”) phone, a wireless local loop (“WLL”) station, a personal digital assistant (“PDA”), a handheld device having wireless connection capability, or some other suitable processing device connected to a wireless modem. Accordingly, one or more aspects taught herein may be incorporated into a phone (e.g., a cellular phone or smart phone), a computer (e.g., a laptop), a tablet, a portable communication device, a portable computing device (e.g., a personal data assistant), an entertainment device (e.g., a music or video device, or a satellite radio), a global positioning system (GPS) device, or any other suitable device that is configured to communicate via a wireless or wired medium. In some aspects, the non-AP station may be a wireless node. Such wireless node may provide, for example, connectivity for or to a network (e.g., a wide area network such as the Internet or a cellular network) via a wired or wireless communication link.

An AP manages a set of STAs (associated with it) that together organize their accesses to the wireless medium for communication purposes. The STAs (including the AP) form a service set, here below referred to as basic service set, BSS (although other terminology can be used). A same physical STA acting as an access point may manage two or more BSSs: each BSS is thus uniquely identified by a specific basic service set identification, BSSID, and managed by a separate virtual AP implemented in the physical AP. Each STA is identified within a BSS thanks to an identifier, AID, assigned to it by the AP upon the association procedure.

The 802.11 family of standards defines various media access control (MAC) mechanisms to drive access to the wireless medium.

The current discussions in the task group 802.11be, as illustrated by draft IEEE P802.11be/D3.0 of March 2023, introduce the Multi-Link Operation (MLO) when it comes to MAC layer operation. The MLO allows multi-link devices to establish or setup multiple links and operate them simultaneously.

A Multi-Link Device (MLD) is a logical entity and has more than one affiliated STA (STA) and has a single medium access control (MAC) service access point (SAP) to logical link control (LLC), which includes one MAC data service. An Access Point Multi-Link Device (or AP MLD) then corresponds to a MLD where each STA affiliated with the MLD is an AP, hence referred to as an “affiliated AP”. A non-Access Point Multi-Link Device (or non-AP MLD) corresponds to a MLD where each STA affiliated with the MLD is a non-AP STA, referred to as an “affiliated non-AP STA”. Depending on the literature, “multilink device”, “ML Device” (MLD), “multilink logical entity”, “ML logical entity” (MLE), “multilink set” and “ML set” are synonyms to designate the same type of ML Device.

Multiple affiliated non-AP STAs of a non-AP MLD can then setup communication links with multiple affiliated APs of an AP MLD, hence forming a multi-link channel.

The links established (or “enabled links”) for MLDs are theoretically independent, meaning that the channel access procedure (to the communication medium) and the communication are performed independently on each link. Hence, different links may have different data rates (e.g. due to different bandwidths, number of antennas, etc.) and may be used to communicate different types of information (each over a specific link).

A communication link or “link” thus corresponds to a given channel (e.g. 20 MHz, 40 MHz, and so on) in a given frequency band (e.g. 2.4 GHz, 5 GHz, 6 GHz) between an AP affiliated with the AP MLD and a non-AP STA affiliated with the non-AP MLD.

The affiliated APs and non-AP STAs operate on their respective channels in accordance with one or more of the IEEE 802.11 standards (a/b/g/n/ac/ad/af/ah/aj/ay/ax/be/bn) or other wireless communication standards.

Thanks to the multi-link aggregation, traffic associated with a single MLD can theoretically be transmitted across multiple parallel communication links, thereby increasing network capacity and maximizing utilization of available resources.

The description below mostly concentrates on a single link for ease of explanation. However; similar considerations can be made with respect to each link forming a multiple link set for MLD devices. Therefore, the term STA may refer to one affiliated STA of a non-AP MLD (non-AP STAs of a non-AP MLD), and AP may refer to one affiliated AP of an AP MLD.

According to some embodiments of the disclosure, two or more neighbouring APs may share resources in terms of frequency and/or time and, in this way, they intend to prevent interferences. Two main roles for APs that participate in a coordination are defined:
sharing AP-the AP that initializes and manages the multi-AP collaboration by sharing resources of its granted TXOP is referred to as the sharing or coordinator AP. It maintains an AP Candidate Set registering the candidate APs for participating in the collaboration, that have requested to be part of the set;
shared APs-all the APs allocated with resources for coordinated transmission by the Sharing AP. Such APs that participate in the multi-AP collaboration and use shared resources are also referred to as coordinated APs. The corresponding BSS is known as the coordinated BSS.

The scope of Multi-AP coordination may be extended to offer an optimized coordination, not only for shared transmissions but also for OBSS Interference reduction. In other words, Multi-AP coordination becomes one of emerging features for interference management in WLAN networks: multiple APs can cooperate together to enhance the performance of the network by smartly managing the interference due to Overlapping Basic Service Sets (OBSSs).

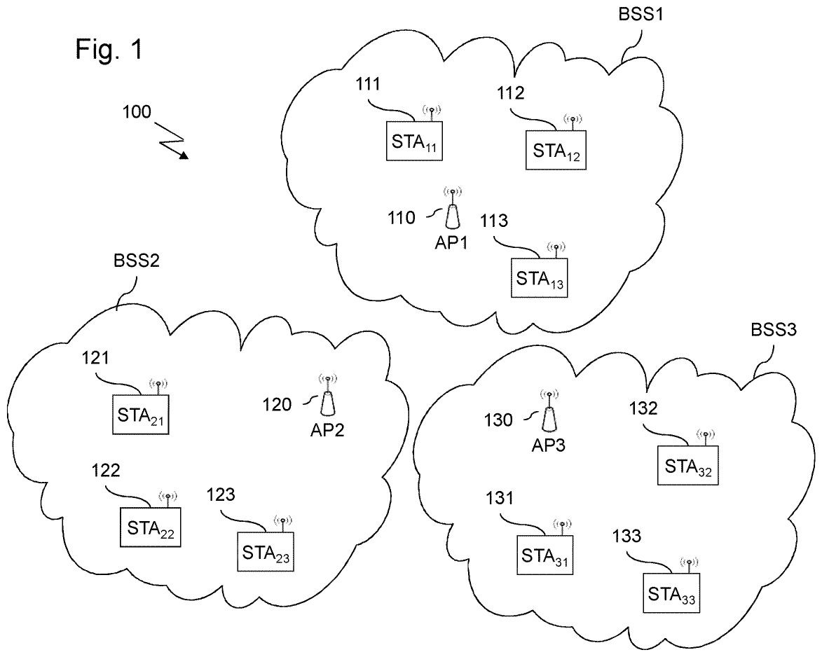

FIG. 1 illustrates an exemplary network environment in which embodiments of the present disclosure may be implemented.

The illustrated wireless network environment comprises a multiple AP system 100 formed by a group of neighbouring wireless networks that operate over a common communication channel or wireless medium. The common communication channel may correspond to a part (e.g. 20 MHz) or all of an operating channel (e.g. 20 MHz, 40 MHz, 80 MHz, 160 MHz or 320 MHz).

A first wireless network BSS1 comprises an access point (AP) 110 and three non-AP stations (STAs) 111, 112 and 113 associated with the AP 110 (i.e., registered with it). A second wireless network BSS2 comprises an AP 120 and three associated non-AP STAs 121, 122 and 123. A third wireless network BSS3 comprises an AP 130 and three associated non-AP STAs 131, 132 and 133. In the following, BSSx represents any of the wireless networks, while 1×1, 1×2 or 1×3 represents any of the non-AP stations. Of course, another number of wireless networks and any number of non-AP stations per wireless network can be contemplated. In the present disclosure, APs 110, 120 and 130 are also referred to, respectively, as AP1, AP2 and AP3. A device may act as an AP of one wireless network and at the same time may belong to another wireless network as an associated STA.

The stations (APs and non-APs) of each wireless network exchange data frames over the communication channel (not represented), under the management of the AP. A primary channel, usually 20 MHz channel, is defined per wireless network on which the management frames are exchanged. The other 20 MHz channels of the communication channel, if any, are known as secondary channels.

Each non-AP STA 1×1 to 1×3 registers to the AP 1×0 of one wireless network BSSx during an association procedure. During the association procedure over the primary channel, the AP assigns a specific Association IDentifier (AID) to the requesting station. For example, the AID is a 16-bit value uniquely identifying the station.

The stations (including the AP) compete one against another over the communication channel (including the primary channel and optionally secondary channels to increase bandwidth) using EDCA (Enhanced Distributed Channel Access) contention to access the communication channel in order to be granted a transmission opportunity (TXOP). The TXOP may then be used to transmit (single-user, SU) data frames or to implement multi-user (MU) transmissions. In the MU scheme, a single station, usually the AP of the wireless network BSSx, is allowed to schedule a MU transmission, i.e. multiple simultaneous transmissions to or from other stations of the wireless network. One implementation of such a MU scheme has been for example adopted in IEEE 802.11ax amendment standard, known as the Multi-User Uplink and Downlink OFDMA (MU UL and DL OFDMA) procedures. In the MU scheme, resources are defined over the 20 MHz channel or channels used, known as resource units.

More generally, the resources may include space, frequency and time resources and may be obtained according to different multiplexing schemes. Examples of those schemes include Spatial Division Multiple Access (SDMA) system, Time Division Multiple Access (TDMA) system, Orthogonal Frequency Division Multiple Access (OFDMA) system, and Single-Carrier Frequency Division Multiple Access (SC-FDMA) system.

In the IEEE 802.11 wireless local area networking standards, the multiple AP system 100 may correspond to an extended service set (ESS) and each of the wireless networks to a basic service set (BSS).

Although the description of embodiments of the disclosure is given in the context of IEEE 802.11, the embodiments are not limited thereto and they may apply to other types of wireless networks and protocols.

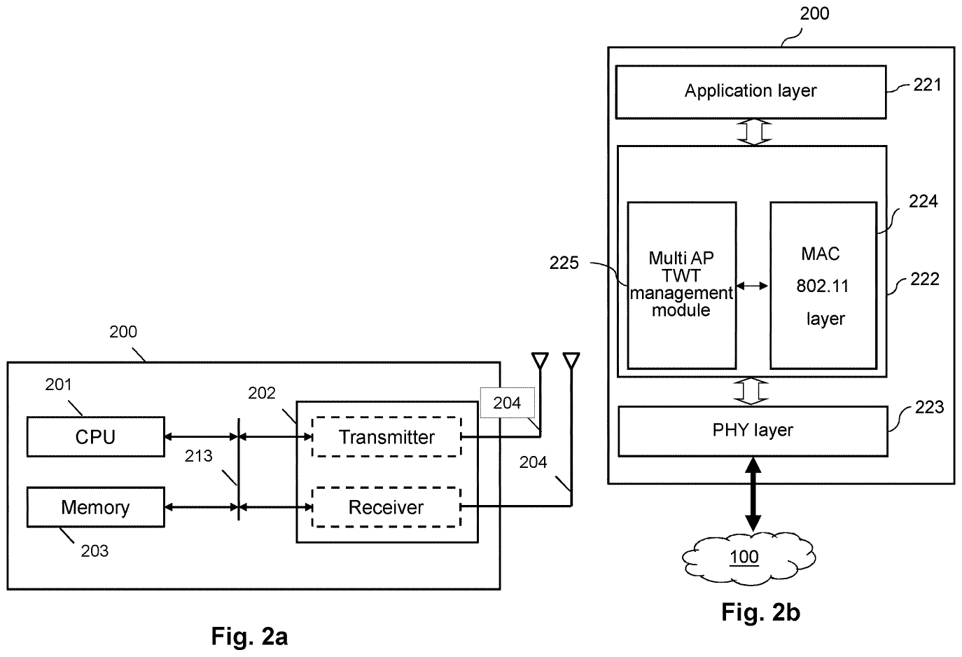

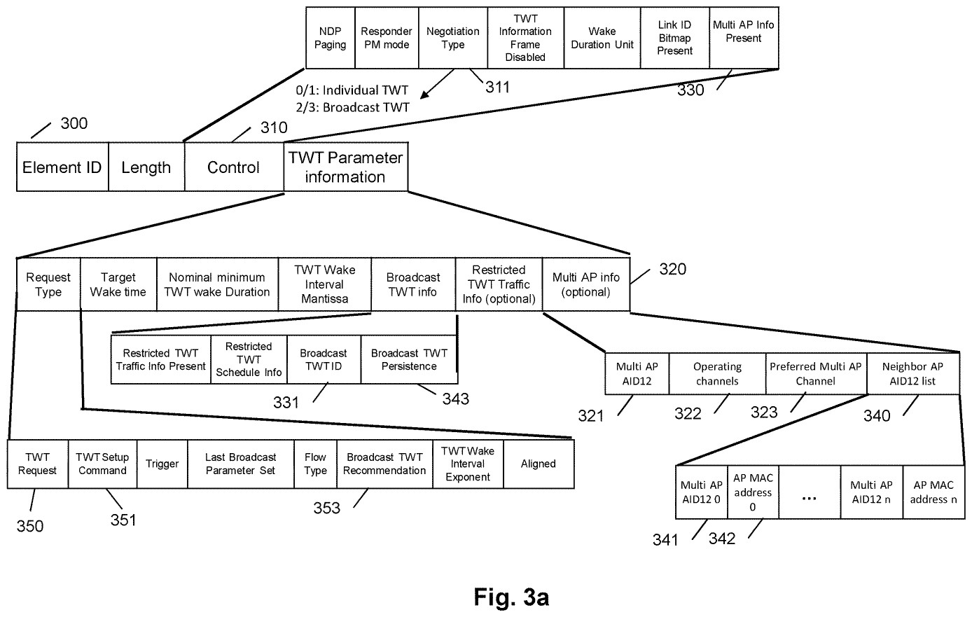

FIG. 2a schematically illustrates a communication device 200 configured to implement at least one embodiment of the present disclosure, for instance any of the (AP and non-AP) stations shown in FIG. 1. The communication device 200 is either a coordinator device, a coordinated device or a mere station managed by the coordinator or coordinated device of a Multi-AP set.

The communication device 200 may preferably be a device such as a micro-computer, a workstation or a light portable device. The communication device 200 comprises a communication bus 213 to which there are preferably connected:
a central processing unit 201, such as a processor, denoted CPU;
a memory 203 for storing an executable code of methods or steps of the methods according to embodiments of the disclosure as well as the registers adapted to record variables and parameters necessary for implementing the methods; and
at least one communication interface 202 connected to a wireless communication network, for example a communication network according to one of the IEEE 802.11 family of standards, via transmitting and receiving antennas 204.

Preferably the communication bus 213 provides communication and interoperability between the various elements included in the communication device 200 or connected to it. The representation of the bus is not limiting and in particular the central processing unit is operable to communicate instructions to any element of the communication device 200 directly or by means of another element of the communication device 200.

The executable code may be stored in a memory that may either be read only, a hard disk or on a removable digital medium such as for example a disk. According to an optional variant, the executable code of the programs can be received by means of the communication network, via the communication interface 202, in order to be stored in the memory of the communication device 200 before being executed.

In an embodiment, the device is a programmable apparatus which uses software to implement embodiments of the disclosure. However, alternatively, embodiments of the present disclosure may be implemented, totally or in partially, in hardware (for example, in the form of an Application Specific Integrated Circuit or ASIC).

FIG. 2b is a block diagram schematically illustrating the architecture of the communication device 200, adapted to carry out, at least partially, the disclosure. As illustrated, device 200 comprises a physical (PHY) layer block 223, a MAC layer block 222, and an application layer block 221.

The PHY layer block 223 (here an 802.11 standardized PHY layer) has the task of formatting, modulating on or demodulating from any 20 MHz channel or the common communication channel, and thus sending or receiving frames over the wireless radio medium used, such as 802.11 frames, for instance medium access trigger frames TF to reserve a transmission slot, MAC data and management frames based on a 20 MHz width to interact with legacy 802.11 stations, as well as of MAC data frames of OFDMA type having smaller width than 20 MHz legacy (typically 2 or 5 MHz)

The MAC layer block or controller 222 preferably comprises a MAC 802.11 layer 224 implementing conventional 802.11be MAC operations, and additional block 225 for carrying out, at least partially, the disclosure. The MAC layer block 222 may optionally be implemented in software, which software is loaded into memory (e.g. RAM) 203 and executed by CPU 201.

Preferably, the additional block 225, referred to as multi-AP interference managing module which has different operations to implement parts of the disclosure, depending on the role played by the communication device 200. As the same device can play different roles over time, the additional block 225 is preferably designed to selectively perform the different operations.

MAC 802.11 layer 224 and multi-AP TWT managing module 225 interact one with the other in order to process accurately single-user and or and multi-user communications addressed to multiple stations according to embodiments of the disclosure.

On the top of FIG. 2, application layer block 221 runs an application that generates and receives data packets, for example data packets such as a video stream. Application layer block 221 represents all the stack layers above MAC layer according to ISO standardization.

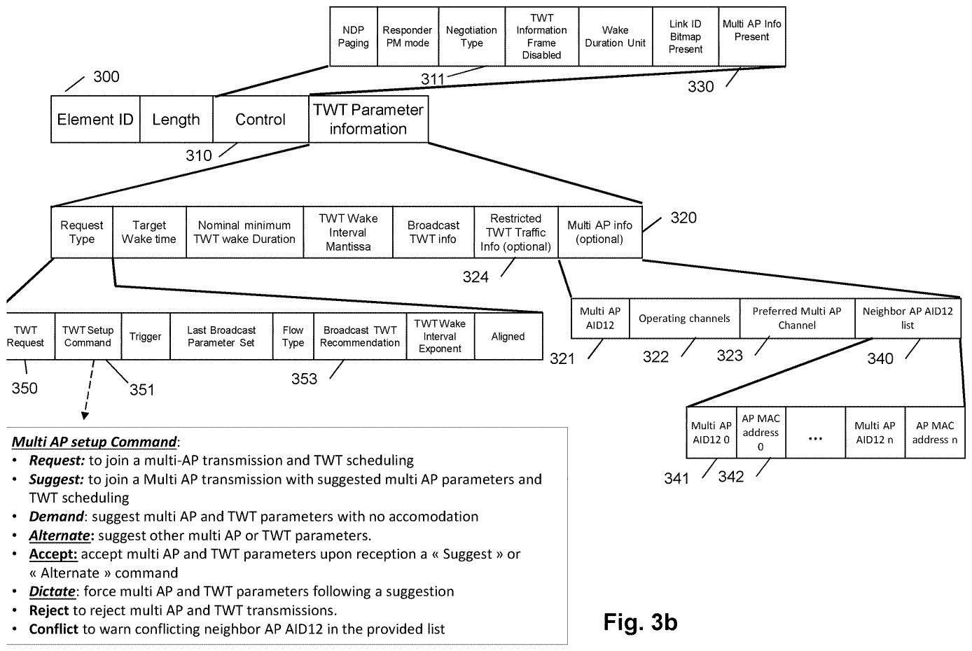

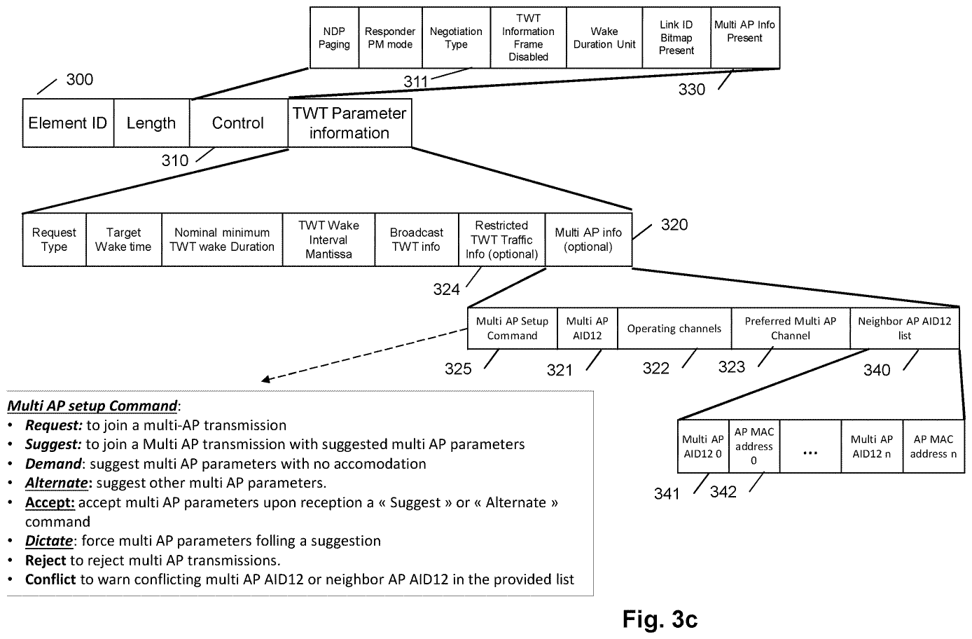

FIG. 3a illustrates an example of a format of a Target Wake Time, TWT, information element enhanced to configure multi-AP transmissions (multi-AP coordination) according to embodiments.

The Target Wake Time (TWT) mechanism, originally defined in the IEEE 802.11ah and 802.11ax standards, has been adapted to be included in the 802.11be D3.0 standard. An adaptation is known as the Restricted Target Wake Time (rTWT) which schedules dedicated (and protected) service periods (SPs) for stations (affiliated with a non-AP MLD) to convey their latency sensitive traffic(s) over their BSS. An rTWT may be seen as a Broadcast TWT agreement negotiated between an AP and an associated non-AP station of the BSS of a given link. The non-AP station establishes with the AP membership in a Broadcast TWT (or rTWT) schedule. The schedule may be defined for some TIDs. The rTWT Service Periods SPs of the rTWT schedule are advertised in broadcast management frames (e.g., beacons), using an rTWT information element about the negotiated rTWT SPs, typically a Broadcast TWT ID (bTWT ID).

Mechanisms like TWT or rTWT are negotiated per link, that is to say between an initiator affiliated STA of the non-AP MLD and the corresponding affiliated AP of the AP MLD.

For a given link, a non-AP station establishes membership in broadcast TWT schedules of the AP, while the AP delivers broadcast TWT parameter sets to the non-AP stations. The non-AP station is said to be the TWT scheduled station, while the AP is said to be the TWT scheduling station.

Negotiations to become a member of or terminate membership in an rTWT schedule (more generally a broadcast TWT) are performed with an exchange of frames that carry TWT elements as shown below, having the Negotiation Type subfield set to 3 (Broadcast TWT). In particular, a non-AP STA MLD may request to become a member of a TWT schedule by transmitting a TWT Setup frame to its associated AP MLD that contains a TWT element for a given rTWT schedule. TWT parameters can be interpreted as request, suggestion, demand, alternation, acceptation, dictation, or rejection. Either the AP or the STA can tear down the TWT by transmitting a TWT Teardown frame.

The AP then advertises the scheduled broadcast TWT (or rTWT) using broadcast TWT elements in its management frames, typically in the beacon frames, FILS Discovery frames and broadcast Probe Response frames.

The TWT parameters are transmitted thanks to an Information Element as described in the section 9.4.2 in the 802.11-2020 Standard and identified by the field 300. The “Control” field 310 allows to detect a broadcast TWT through the “Negociation Type” field 311. The MSB bit of this field is set to 1 to promote a broadcast TWT. Next, the TWT scheduling AP sets the “TWT Request” subfield 350 to 0 and the TWT Setup Command subfield 351 as “Accept” to announce the next TWT SP, as “Alternate” to announce the next TWT SP with a new set of TWT parameters and as “Reject” to tear down a broadcast TWT (the ending date is identified in the “Broadcast TWT Persistence” subfield 343. The broadcast TWT includes the broadcast TWT element 320 defining the set of TWT parameters. Each broadcast TWT is identified by a “Broadcast TWT ID” field 331 allowing an AP to schedule multiple sets of broadcast TWT SPs with different sets of TWT parameters. A STA may request to become a member of a broadcast TWT by transmitting a frame to its associated AP that contains a TWT element with the “Negotiation Type” subfield 311 set to 3 and the “TWT Setup Command” field 351 set to “Request TWT” or “Suggest TWT” or “Demand TWT”. The attached TWT Parameter set indicates the Broadcast TWT ID of the broadcast TWT that the STA is requesting to join.

The “Broadcast TWT Recommendation” field 353 is used in the 802.11 standard to advise STAs to send PS-Poll, QOS Null, BQR or BSR frames when they are solicited by the AP. But it is only a recommendation. If STAs wants to transmit any other kinds of frames, there is no pure restriction. The 802.11be amendment introduced a new value “4” to define a new format of TWT named restricted TWT (rTWT). In one embodiment, a further new value (for instance “5” but it can be any other value) could be added to define a TWT information element indicating the usage of the 2 features at the same time: restricted TWT and multi-AP feature.

In another embodiment, the support of the multi-AP feature can be added by setting the value “1” a bit such as a “Multi AP Info Present” field 330. The “Multi AP Info Present” field 330 indicates the presence of the optional “Multi AP info” field 320.

The “Multi AP info” field 320 contains all parameters used to configure a multi-AP transmission. In that case, an AP can include the multi-AP (MAP) information element within any management frame supporting the information element format (such as beacon frame, prob request, response frame, etc.) to advertise its multi-AP parameters to all neighboring APs. Particularly, the field 321 “Multi AP AID12” defines the AID12 assigned to an AP to be triggered by another AP. As a reminder, a trigger frame is a frame used by an AP to allocate bandwidth for multi user transmissions. Each user info field of a trigger frame allows to solicit a STA by using an association identifier (so called AID12). The AID12 value is allocated when a STA associates with an AP that provide this AID12 value. Previously, there was no procedure to allocate an AID12 value for an AP in the 802.11-2020 standard. So, this field “Multi AP AID12” is a way to spread the AID12 value of an AP to all other neighboring APs. This allocation is especially useful to schedule multi-AP transmissions. The field 322 “Operating channels” defines the list of the operating channels wherein the AP operates. The field 323 “preferred Multi AP channel” defines the preferred channel to be used for multi-AP transmissions because an AP can dedicate only a part of its operating channels for multi-AP transmissions. The field 340 “Neighbor AP AID12 list” contains a set of multi-AP AID12 values (341) and the associated MAC address (342) of the APs that were already received by the AP broadcasting its multi-AP parameters. It is a way to spread easily multi-AP parameters of all the neighboring APs.

FIGS. 3b and 3c illustrate examples of a format of a Multi-AP (MAP) Target Wake Time (TWT) information element to negotiate multi-AP transmissions according to some embodiments of the disclosure.

As described with reference to FIG. 3a, the negotiation to become a member of or terminate membership in a multi-AP transmission schedule are performed with an exchange of frames that carry multi-AP TWT information element as described hereafter, having the Negotiation Type subfield set to 3 (Broadcast TWT). In particular, a non-AP STA MLD may request to become a member of a multi-AP transmission schedule by transmitting a multi-AP TWT Setup frame to its associated AP MLD that contains a multi-AP information element for a given multi-AP transmission schedule. Multi-AP information elements can be interpreted as suggestion, demand, alternation, acceptation, dictation, conflict, or rejection. Either the AP or the STA can tear down the multi-AP TWT by transmitting a multi-AP TWT Teardown frame.

Again, the TWT parameters are transmitted thanks to an Information Element as described in the section 9.4.2 in the 802.11-2020 Standard and identified by the field 300. The “Control” field 310 makes it possible to detect a broadcast TWT through the “Negociation Type” field 311. The MSB bit of this field is set to 1 to promote a broadcast TWT. Next, as illustrated in FIG. 3b, the TWT scheduling AP sets the “TWT Request” subfield 350 to 0 and the TWT Setup Command subfield 351 as “Accept” to announce the next TWT SP, as “Alternate” to announce the next TWT SP with a new set of TWT parameters and as “Reject” to tear down a broadcast TWT (the ending date is identified in the “Broadcast TWT Persistence” subfield (not represented). The broadcast TWT includes the broadcast TWT element 320 defining the set of TWT parameters. Each broadcast TWT is identified by a “Broadcast TWT ID” field (not represented) allowing an AP to schedule multiple sets of broadcast TWT SPs with different sets of TWT parameters.

According to the embodiment illustrated in FIG. 3b, a sharing AP may request to become a member of a multi-AP TWT by transmitting a frame to a shared AP that contains a multi-AP TWT element with the “Negotiation Type” subfield 311 set to 3 and the “TWT Setup Command” field 351 set to “Request TWT” or “Suggest TWT” or “Demand TWT”. The attached restricted TWT parameters are located in the “Restricted TWT Traffic info” subfield 324 and the multi-AP parameters are located in the “multi-AP info” subfield 320. In response, the shared AP TWT may answer by transmitting a frame to the sharing AP that contains a multi-AP TWT element with the “Negotiation Type” subfield 311 set to 3 and the “TWT Setup Command” field 351 set to “Alternate” or “Accept” or “Dictate” or “Reject” or “Conflict”.

According to the embodiment illustrated in FIG. 3c, a sharing AP may request to become a multi-AP TWT by transmitting a frame to a responder AP that contains a multi-AP TWT element with the “Negotiation Type” subfield 311 set to 3, the “Multi-AP Info Present” subfield 330 set to 1 and the “Multi-AP Setup Command” field 325 set to “Request TWT” or “Suggest TWT” or “Demand TWT”. The attached restricted TWT parameters are located in the “Restricted TWT Traffic info” subfield 324 and the multi-AP parameters are located in the “multi-AP info” subfield 320. In response, the responder AP TWT may answer by transmitting a frame to the sharing AP that contains a multi-AP TWT element with the “Negotiation Type” subfield 311 set to 3 and the “Multi-AP Setup Command” field 325 set to “Alternate” or “Accept” or “Dictate” or “Reject” or “Conflict”.

The “Broadcast TWT Recommendation” field 353 (FIG. 3b) is used in the 802.11 standard to advise STAs to send PS-Poll, QOS Null, BQR, or BSR frames when they are solicited by the AP. But it is only a recommendation. If STAs wants to transmit any other kinds of frames, there is no pure restriction. The 802.11be amendment introduced a new value “4” to define a new format of TWT named restricted TWT (rTWT). In one embodiment, a new value (for instance “5”) could be added to define a TWT information element indicating the usage of the 2 features at the same time: restricted TWT and multi-AP feature.

In another embodiment, the support of the multi-AP feature can be added by setting the value “1” a bit such as a “Multi AP Info Present” field 330. The “Multi AP Info Present” field 330 indicates the presence of the optional “Multi AP info” field 320.

The “Multi AP info” field 320 contains all the parameters used to negotiate the configuration for the next multi-AP transmissions with one or more AP. In this case, an AP may include the multi-AP (MAP) TWT information element within any management frame supporting the information element format (such as beacon frame, prob request, response frame, etc.) to advertise its multi-AP parameters to all neighboring APs. In particular, the field 321 “Multi AP AID12” defines the AID12 assigned to an AP to be triggered by another AP. As a reminder, a trigger frame is a frame used by an AP to allocate bandwidth for multi user transmissions. Each user info field of a trigger frame makes it possible to solicit a STA by using an association identifier (so called AID12). The AID12 value is allocated when a STA associates with an AP that provides this AID12 value. Currently, there is no procedure to allocate an AID12 value for an AP in the 802.11-2020 standard. So, this field “Multi AP AID12” is a way to spread the AID12 value of an AP to all other neighboring APs. This allocation is especially useful to schedule multi-AP transmissions. The field 322 “Operating channels” defines the list of the operating channels wherein the AP operates. The field 323 “preferred Multi AP channel” defines the preferred channel to be used for multi-AP transmissions because an AP can dedicate only a part of its operating channels for multi-AP transmissions. The field 340 “Neighbor AP AID12 list” contains a set of multi-AP AID12 values (341) and the associated MAC address (342) of the APs that were already received by the AP broadcasting its multi-AP parameters. It is a way to spread easily multi-AP parameters of all the neighboring APs.

The MAP setup commands described in the disclosure, in particular with reference to FIGS. 3a, 3b, and 3c, may be the following:
the request MAP setup command aims at joining a multi-AP transmission;
the suggest MAP setup command aims at joining a multi-AP transmission while suggesting multi-AP parameters;
the demand MAP setup command aims at suggesting multi-AP parameters without any accommodation;
the alternate MAP setup command aims at suggesting multi-AP parameters other than the multi-AP parameters associated with a MAP setup command previously received;
the accept MAP setup command aims at accepting multi-AP parameters associated with a suggest or alternate MAP setup command previously received;
the dictate MAP setup command aims at forcing the use of multi-AP parameters associated with a suggest MAP setup command previously received;
the reject MAP setup command aims at rejecting multi-AP transmissions; and
the conflict MAP setup command aims at warning conflicting multi-AP AID12 or neighbor AP AID12 in a provided list.

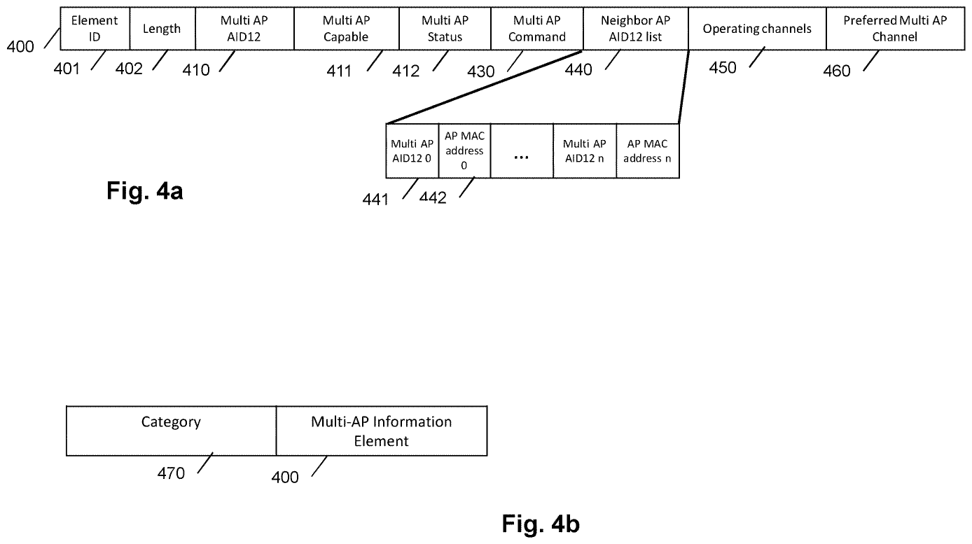

FIGS. 4a and 4b illustrate a format of information element enhanced to configure multi-AP transmissions according to some embodiments.

In another embodiment, the multi-AP parameters is spread within a dedicated information element, not linked with the restricted TWT information element. The Multi AP (MAP) information element (IE) can be typically included in a beacon frame to broadcast the Multi AP capabilities of an AP to all its neighboring APs. The MAP IE 400 contains a set of fields gathering required parameters to perform multi-AP transmissions:
an Element ID field 401 identifying the multi-AP element,
a Length field 402 indicating the number of bytes in the element excluding the Element ID field and the Length field,
a Multi-AP AID12 field 410 indicating the AID12 assigned to an AP to be triggered by another AP. It is the same field as the field 321 described previously,
a Multi AP capable subfield 411 indicating the capability for an AP to support a multi-AP transmission. For instance, the value of this field may be equal to 1 to indicate supporting the Multi AP feature, 0 otherwise,
a Multi AP status subfield 412 indicating that the AP is currently supporting or not the multi-AP feature. For instance, the value of this field can be equal to 1 to enable the multi-AP feature, 0 otherwise,
a field 450 “Operating channels” defining the list of the operating channels wherein the AP operates,
a field 460 “preferred Multi AP channel” defining the preferred channel to be used for multi-AP transmissions because an AP can dedicate only a part of its operating channels for multi-AP transmissions, and
a field 440 “Neighbor AP AID12 list” containing a set of multi-AP AID12 values (441) and the associated MAC address (442) of the APs that were already received by the AP broadcasting its multi-AP parameters. It is a way to spread easily multi-AP parameters of all the neighboring APs.

The MAP IE can be transmitted also thanks to a dedicated Action frame. As specified in the 802.11 standard, an Action frame provides mechanism for specifying extended management actions. The Category field 470 specifies the category of action dedicated to the multi-AP feature and the field 400 corresponds to all fields specified in the MAP IE. This frame can be unicast, multicast or broadcast. This allows advertising multi-AP feature to one neighboring AP, a set of neighboring APs or all neighboring APs.

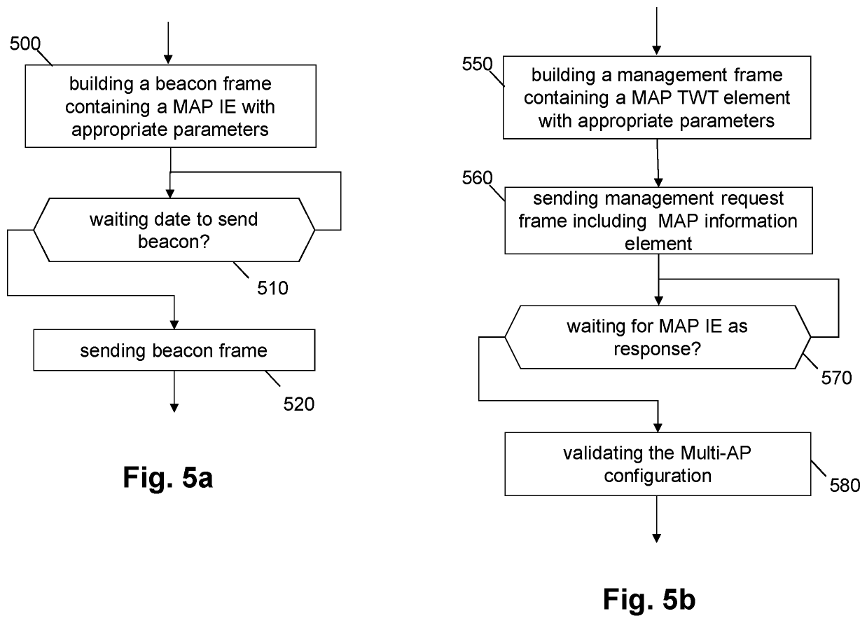

FIGS. 5a and 5b illustrate, using a flowchart, general steps at a sharing AP according to embodiments of the disclosure.

A sharing AP is an AP that wants to initiate multi-AP transmissions. On the contrary, a shared AP is an AP that receives multi-AP parameters from sharing APs and that is solicited for multi-AP transmissions by the sharing AP. It has to be noted that an AP is not uniquely a sharing AP or a shared AP. This naming depends on the running procedure.

A sharing AP needs to share its multi-AP parameters with one or part of or all neighboring APs.

FIG. 5a is a flowchart used by a sharing AP to broadcast multi-AP parameters to all neighboring APs. An AP is a neighbor AP of another AP if it is enabled to receive frames from the other AP. Step 500 sets the appropriate value for all fields described in FIG. 3 corresponding to the desired multi-AP configuration. As the beacon frame is periodically sent, the AP sends the beacon frame built at step 500 on the next date to send a beacon frame (steps 510 and 520).

FIG. 5b is another embodiment to advertise the MAP IE encapsulated within a management request frame (such prob request or action frame) (step 550). Step 560 sends the just built management request frame to the destined shared AP. A response is waited by the sharing AP to acknowledge the multi-AP configuration associated to the multi-AP parameters encapsulated in the previously sent management request frame.

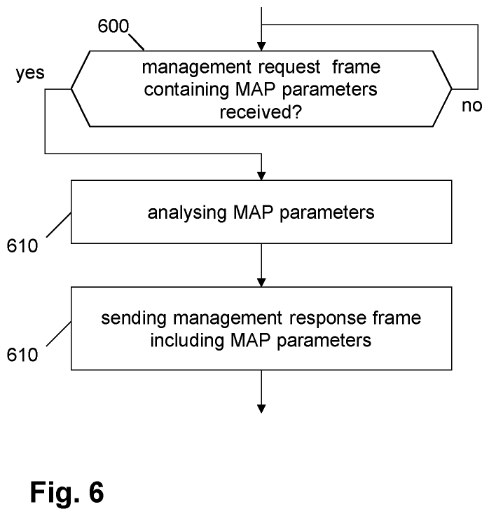

FIG. 6 illustrates, using a flowchart, general steps at a shared AP according to embodiments of the disclosure.

Upon the reception of a management frame including a MAP IE from a sharing AP (600), the shared AP compares its multi-AP parameters with those received from the sharing AP (610). In response, the shared AP sends a management response frame including its own multi-AP parameters (620).

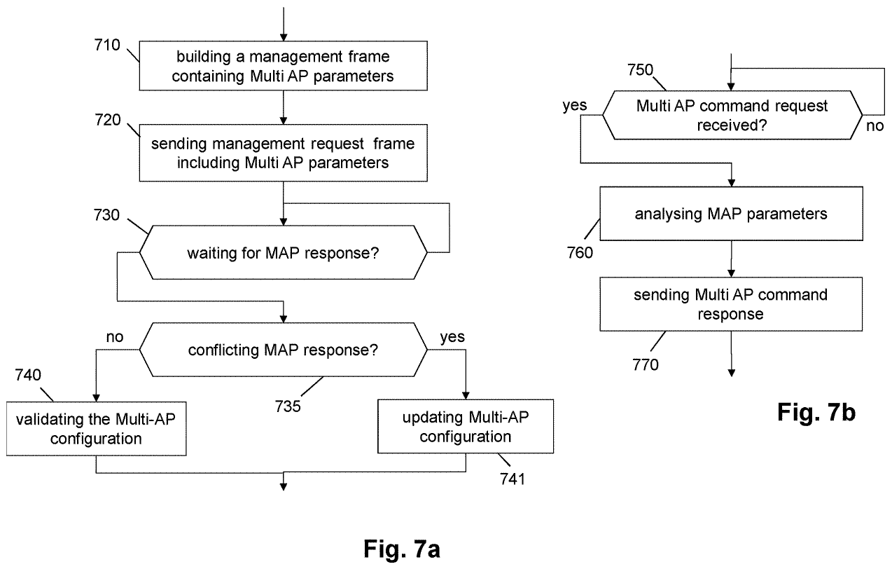

FIGS. 7a and 7b illustrate, using a flowchart, general steps of an example of a managing multi AP negotiation procedure, at a sharing AP and at a shared AP, respectively, according to embodiments of the disclosure.

At step 710, a sharing AP may request to become a member of a multi-AP TWT by transmitting a frame (management request frame) to a shared AP, the management request frame containing a multi-AP TWT element with the “Negotiation Type” subfield (reference 311 in FIG. 3b) set to 3. According to one embodiment, the “TWT Setup Command” field (reference 351 in FIG. 3b) of the multi-AP TWT element is set to “Request TWT” or “Suggest TWT” or “Demand TWT”. In another embodiment, the multi-AP commands are defined thanks to the “Multi-AP Setup Command” field (reference 325 in FIG. 3c) set to “Request TWT” or “Suggest TWT” or “Demand TWT”.

The attached restricted TWT parameters are located in the “Restricted TWT Traffic info” subfield (reference 324 in FIGS. 3b and 3c) and the multi-AP parameters are located in the “multi-AP info” subfield (reference 320 in FIGS. 3b and 3c). A multi-AP command is set to “Request TWT” to join a multi-AP transmission group or more generally a TWT group with no parameters associated with the request. A multi-AP command is set to “Suggest TWT” to join a multi-AP transmission group or more generally a TWT group with suggested parameters for the multi-AP transmission. A multi-AP command is set to “Demand TWT” to join a multi-AP transmission group or more generally a TWT group with required parameters for the multi-AP transmission with no accommodation.

Next, the built management request frame is sent (step 720) to the shared AP. A response is waited from one or more shared APs (step 730).

Upon receiving a management request frame containing a multi-AP information element (step 750), the shared AP may answer by transmitting a frame (management response frame) to the sharing AP that contains a multi-AP TWT element with the “Negotiation Type” subfield (reference 311 in FIGS. 3b and 3c) set to 3. According to in one embodiment, the “TWT Setup Command” field (reference 351 in FIG. 3b) is set to “Alternate” or “Accept” or “Dictate” or “Reject” or “Conflict” depending on the analysis of the recommended or required multi-AP parameters received from the sharing AP (step 760). In another embodiment, the multi-AP command are defined thanks to the “Multi-AP Setup Command” field (reference 325 in FIG. 3c) set to “Alternate” or “Accept” or “Dictate” or “Reject” or “Conflict”.

The multi-AP command may be set to “Accept” to accept the multi-AP command just received from the sharing AP with no modifications. Alternately, the multi-AP command may be set to “Alternate” to suggest a new set of multi-AP parameters to the sharing AP. Alternately, the multi-AP command may be set to “Dictate” to force a different set of multi-AP parameters in response to the multi-AP command received from the sharing AP. Alternately, the multi-AP command may be set to “Reject” to reject the multi-AP transmission asked from the sharing AP. Alternately, the multi-AP command may be set to “Conflict” when a conflict is detected in the multi-AP AID12 field (reference 321 in FIGS. 3b and 3c) or in the list of AID12 of the neighbor APs (reference 340 in FIGS. 3b and 3c)). For instance, when a first AP (AP1) sends its list of neighbor APs, an second AP (AP2) may detect some AID12 conflict for a third AP (AP3) that is not detectable by the first AP (hidden AP scenario).

Next, the management response frame is sent (step 770).

Upon receiving a management response frame (step 730), the sharing AP analyses the received management response frame to determine (step 735) whether the sharing AP configuration is to be validated (step 740), for example if MAP parameters are accepted by the shared AP, or is to be updated (step 741), for example if a dictate command is received further to suggesting MAP parameters or if there is a conflict of AIDs.

It is noted that in case of conflicting MAP parameters, the sharing AP may send a multi-AP command set to “Alternate” with updated multi-AP parameters to the one or more shared APs.

According to another embodiment, the multi-AP parameters may be transmitted within a dedicated action frame as described in FIG. 4a. This action frame may transmit Multi-AP request and response commands.

It is noted that expressions such as “comprise”, “include”, “incorporate”, “contain”, “is” and “have” are to be construed in a non-exclusive manner when interpreting the description and its associated claims, namely construed to allow for other items or components which are not explicitly defined also to be present. Reference to the singular is also to be construed in be a reference to the plural and vice versa.

A person skilled in the art will readily appreciate that various parameters disclosed in the description may be modified and that various embodiments disclosed may be combined without departing from the scope of the disclosure.

1. A communication method in a wireless network, comprising, at an access point, AP, of a plurality of APs in the wireless network:
transmitting or receiving a management frame;
wherein the management frame comprises multi access point, MAP, parameters to be used for coordinating APs, wherein the MAP parameters include at least one of:
an Association Identifier, AID, assigned to an AP to be triggered by another AP,
an operating channel wherein an AP transmitting the management frame operates,
a preferred channel to be used for MAP transmissions, and
AIDs of neighboring APs.

2. The method of claim 1, wherein the management frame is a transmitted management request frame, the management request frame comprising a MAP setup command, the MAP setup command being a request command for joining a MAP transmission, a suggest command for joining a MAP transmission with suggested MAP parameters, or a demand command suggesting MAP parameters to be used for coordinating APs.

3. The method of claim 2, further comprising, in response to transmitting the management request frame, receiving a management response frame, the management response frame comprising an alternate MAP setup command suggesting the use of MAP parameters different from the corresponding parameters of the management request frame.

4. The method of claim 2, further comprising, in response to transmitting the management request frame, receiving a management response frame, the management response frame comprising an accept MAP setup command accepting MAP parameters associated with a suggest or alternate command of the management request frame.

5. The method of claim 2, further comprising, in response to transmitting the management request frame, receiving a management response frame, the management response frame comprising a dictate MAP setup command forcing the use of MAP parameters associated with a suggest command of the management request frame.

6. The method of claim 2, further comprising, in response to transmitting the management request frame, receiving a management response frame, the management response frame comprising a reject MAP setup command rejecting MAP parameters or comprising a conflict command warning conflicting AIDs.

7. The method of claim 1, wherein the management frame is a received management request frame, the management request frame comprising a request MAP setup command for joining a MAP transmission, a suggest command to join a MAP transmission with suggested MAP parameters, or a demand command suggesting MAP parameters to be used for coordinating APs.

8. The method of claim 7, further comprising, in response to receiving the management request frame, analyzing the received management request frame and, in response to the analysis, generating and transmitting a management response frame, the management response frame comprising an alternate MAP setup command suggesting MAP parameters different from the corresponding parameters of the management request frame.

9. The method of claim 7, further comprising, in response to receiving the management request frame, analyzing the received management request frame and, in response to the analysis, generating and transmitting a management response frame, the management response frame comprising an accept MAP setup command accepting MAP parameters associated with a suggest or alternate command of the management request frame.

10. The method of claim 7, further comprising, in response to receiving the management request frame, analyzing the received management request frame and, in response to the analysis, generating and transmitting a management response frame, the management response frame comprising a dictate MAP setup command forcing the use of MAP parameters associated with a suggest command of the management request frame.

11. The method of claim 7, further comprising, in response to receiving the management request frame, analyzing the received management request frame and, in response to the analysis, generating and transmitting a management response frame, the management response frame comprising a reject MAP setup command rejecting MAP parameters received in the management request frame or comprising a conflict MAP setup command warning conflicting AIDs.

12. The method of claim 1, wherein the management frame comprises a Target Wake Time, TWT, information element, the TWT information element comprising the parameters and comprising TWT parameters associated with a MAP setup command.

13. The method of claim 12, wherein the TWT information element comprises a TWT Setup Command field, the TWT Setup Command field comprising a request, suggest, demand, alternated, accept, dictate, reject, or conflict MAP setup command to be transmitted or received.

14. The method of claim 12, wherein the TWT information element comprises a MAP Setup Command field, the MAP Setup Command field comprising a request, suggest, demand, alternated, accept, dictate, reject, or conflict MAP setup command to be transmitted or received.

15. The method of claim 2, wherein the management frame comprises a Target Wake Time, TWT, information element, the TWT information element comprising the parameters and comprising TWT parameters associated with a MAP setup command.

16. The method of claim 7, wherein the management frame comprises a Target Wake Time, TWT, information element, the TWT information element comprising the parameters and comprising_ TWT parameters associated with a MAP setup command.

17. A non-transitory computer-readable storage medium storing instructions of a computer program for implementing the method according to claim 1.

18. A processing device comprising a processing unit configured for carrying out each step of the method according to claim 1.

19.-22. (canceled)
